(19) United States
(12) Patent Application Publication
(10) Pub. No.: US 2007/0082187 A1
(43) Pub. Date: Apr. 12, 2007

(54) Celluosic products comprising substantially voc-free compositions

(75) Inventors: Yin Wang, Bellingham, WA (US); Wenbo Jiang, Ferndale, WA (US)

Correspondence Address: KLARQUIST SPARKMAN, LLP, 121 SW SALMON STREET, SUITE 1600, PORTLAND, OR, 97204, US

(73) Assignee: Chemco, Inc.

(21) Appl. No.: 11/477,096

(22) Filed: Jun. 27, 2006

Related U.S. Application Data
(60) Provisional application No. 60/694,734, filed on Jun. 27, 2005.

(51) Int. Cl. C08L 97/02; C08L 1/00

(52) U.S. Cl. 428/292.1; 106/164.3; 106/162.5; 106/200.2

(57) ABSTRACT

Embodiments of a composition useful for forming cellulosic products are disclosed, as well as products made using disclosed compositions. One disclosed composition comprises effective amount of dihydroxyethylene urea(s), dihydroxypropanol ureas, glycoluril(s), or combinations thereof. Such compositions can be cross linked, or not. The compositions can include other materials, such as methylol melamine; maltodextrin, where the DE of the maltodextrin can vary from about 4 to about 25, optional auxiliary additives, including a surfactant; a trialkanolamine, a preservative, a fire retardant; an aesthetic material, such as a dye that, in certain embodiments, substantially completely penetrates the cross section of the board product; a hardness enhancer; and any and all combinations of such materials. One embodiment of a disclosed method for making a cellulosic product comprises first providing a disclosed composition and applying it to cellulosic material, such as by substantially immersing cellulosic material in desired compositions in an autoclave.

### CROSS REFERENCE TO RELATED APPLICATION

This application claims the benefit of the earlier filing date of U.S. provisional application No. 60/694,734, which is incorporated herein by reference.

### FIELD

This application concerns a composition useful for making cellulosic products, cellulosic products made using the composition, and a method for their manufacture.

### BACKGROUND

Some cellulosic products are made directly from harvested trees. However, many, if not most, of the modern commercial wood products are formed by combining cellulosic materials as particles, chips or fibers, with polymeric compositions.

A known polymeric composition developed by the assignee of the present application and useful for making cellulosic products comprises melamine, urea, and formaldehyde. U.S. Pat. No. 5,162,394 (the '394 patent), entitled “Fire Retardant Chemical Compositions,” which is incorporated herein by reference, discusses embodiments of the composition comprising a resin A and a resin B.

Resin A comprises maltodextrin and glyoxal. Maltodextrin is an intermediate-length polysaccharide comprising maltose and glucose that is made, for example, by enzymatic hydrolysis of starch obtained from barley or other grains. The relative amounts of maltose and glucose can vary. The degree of polymerization also can vary, and is measured by the dextrose equivalents (DE), a quantitative measure of the degree of starch polymer hydrolysis, with higher DE values indicating greater starch hydrolysis. Glyoxal is a dialdehyde (OHCCHO) that can condense with compounds having reactive functional groups, such as hydroxyl (—OH) groups. The composition taught by the '394 patent also includes urea.

Resin B comprises, for example, a methylol-melamine-formaldehyde resin. While the polymerization chemistry for this system is complicated, and without being limited to a mode of operation, it currently is believed that the formaldehyde reacts with the melamine to form methylol melamine. Complete polymerization of the melamine and formaldehyde is inhibited by controlling the pH, i.e. maintaining the pH of the solution relatively high to inhibit complete polymerization. A second possible formulation of resin B includes urea that reacts with formaldehyde to form methylol ureas. Modified urea serves as a cross-linking agent for the resin A polymer.

The composition described in the '394 patent is quite useful for making cellulosic compositions. Furthermore, the composition also can be used in combination with fire-retardant chemicals to make fire-retardant chemical compositions and fire-retardant cellulosic compositions. While formaldehyde emission from this composition is quite low, compositions and products that provide even lower formaldehyde emission, or completely eliminate formaldehyde emission, are desirable.

There are many additional patents that describe polymeric compositions useful for making cellulosic products, many of which potentially evolve formaldehyde, including U.S. Pat. No. 5,770,319 and U.S. Pat. No. 6,428,902. U.S. Pat. No. 5,770,319, entitled “Densification of Lignocellulosic Material,” discloses impregnating wood with a maltodextrin solution under vacuum and/or pressure. Maltodextrins having a dextrose equivalent (DE) in the range of 15-30 are preferred, and the maltodextrin can be cross-linked. U.S. Pat. No. 6,428,902, entitled “Method of and Compositions for Treating Wood,” concerns wood preservative formulations.

Formaldehyde emission from composite products is regulated by the United States government. For example, regulations promulgated by the Department of Housing and Urban Development (HUD) for materials used in mobile homes limit formaldehyde emissions to 0.3 ppm. The American National Standards Institute (ANSI) for particle board products restricts formaldehyde gas emissions to 0.2 ppm as measured by the American Society for Testing Materials (ASTM) chamber test. Formaldehyde emissions for particle board products have been reduced by changing urea-formaldehyde resin formulations to decrease formaldehyde-to-urea ratios (F/U) from 1.6 to 1.4. Other processes have been designed ostensibly to decrease formaldehyde emissions, such as by coating the board product with polyurethanes.

There still is a need to produce useful wood composites and reduce emissions of volatile organic compounds (VOC), particularly formaldehyde.

### SUMMARY

Embodiments of a composition useful for forming cellulosic products are disclosed, as well as embodiments of a method for making cellulosic products using the composition, and embodiments of products made by the method. One embodiment of a disclosed composition comprises an effective amount of a 5-membered ring compound, a 6-membered ring compound, or combinations thereof, that result by reacting urea with a dialdehyde. For example, the composition may include dihydroxyethylene ureas, glycolurils, dihydroxypropanol ureas, or combinations thereof. Particular embodiments comprise methylol melamine or a derivative thereof. Certain of the embodiments include a crosslinking agent for cross linking the composition. The composition may be formulated as an aqueous composition, a composition comprising an organic solvent, particularly polar organic solvent compositions, such as alcohols, including without limitation methanol, and aqueous/organic compositions.

Particular compositions include compounds having a formula 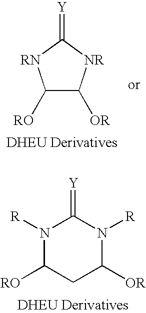
With reference to these general formulas, R independently is H, aliphatic, including lower (10 carbon atoms or fewer) aliphatic, CH(OH)CHO, or combinations thereof, and Y is oxygen or sulfur, typically oxygen.

Certain disclosed compositions also include maltodextrin. A person of ordinary skill in the art will appreciate that maltodextrins having varying degrees of polymerization can be used. The degree of polymerization can be measured using dextrose equivalents (DE). Maltodextrins useful for practicing the present invention typically have a DE of from 4 to about 25, more typically a DE of from about 4 to 12.

The compositions may further optionally comprise auxiliary additives, including by way of example and without limitation: a surfactant; a trialkanolamine, particularly lower alkyl trialkanolamines, such as triethanolamine; a preservative, such as a borate, a benzoate, a carbonate, a carboxylate, an amine oxide, an amine ethoxylate, metal azole, or combinations thereof, with specific examples of preservatives including sodium benzoate, chromated copper arsenate, didecyl dimethyl ammonium carbonate, didecyl dimethyl ammonium bicarbonate, copper quaternary amine compounds, copper boron azole, copper azole, acid copper chromate, copper citrate, sodium borate, zinc borate, or combinations thereof; a fire retardant; an aesthetic material, such as a dye and/or pigment that, in certain embodiments, substantially completely penetrates the cross section of the board product; a hardness enhancer, such as a nanoclay, a silicate, an inorganic salt, a borate or combinations thereof, or all combinations of such materials.

A particular example of a composition useful for forming cellulosic products comprises effective amounts of dihydroxyethylene urea(s), glycoluril(s), dihydroxypropanol ureas, methylol melamine, and maltodextrin having a DE of from 4 to about 25, more typically from about 4 to 12. As with the other embodiments, the composition may include optional auxiliary additives.

Still another embodiment of a particular composition useful for forming cellulosic products, comprises effective amounts of dihydroxyethylene ureas, glycolurils, methylol melamine, maltodextrin having a DE of from 4 to about 25, and an auxiliary additive selected from the group consisting of a surfactant, a trialkanolamine amine, a preservative, a fire retardant, an aesthetic material, a hardness enhancer, and combinations thereof.

Wood products having various embodiments of the disclosed compositions also are described. A wood product optionally may include a dye material penetrating substantially completely through a cross section of the product, with or without a composition comprising dihydroxyethylene urea(s), glycouril(s), and combinations thereof.

One embodiment of a disclosed method for making a cellulosic product comprised first providing any or all of the materials discussed herein useful for making cellulosic compositions. The composition is applied to a cellulosic material. Applying may comprise substantially impregnating a board product with the composition, and can be accomplished as desired. For example, applying may comprise substantially immersing cellulosic material in desired compositions in an autoclave, and first decreasing the pressure below ambient followed by increasing the pressure in the autoclave to greater than ambient.

Another embodiment of a disclosed method comprises providing a board product. A dye material is applied to the board product to provide dye material substantially completely through a cross section of the product. This disclosed embodiment may further comprise applying a composition to the board product comprising effective amounts of dihydroxyethylene urea, dihydroxypropanol ureas, methylol melamine, a maltodextrin having a DE of from 4 to about 25, an auxiliary additive selected from a surfactant, a trialkanolamine amine, a preservative, a fire retardant, an aesthetic materials or a hardness enhancer, or combinations thereof.

### BRIEF DESCRIPTION OF THE DRAWINGS

FIG. 1 is a block diagram listing process steps useful for implementing a disclosed embodiment of the present invention.

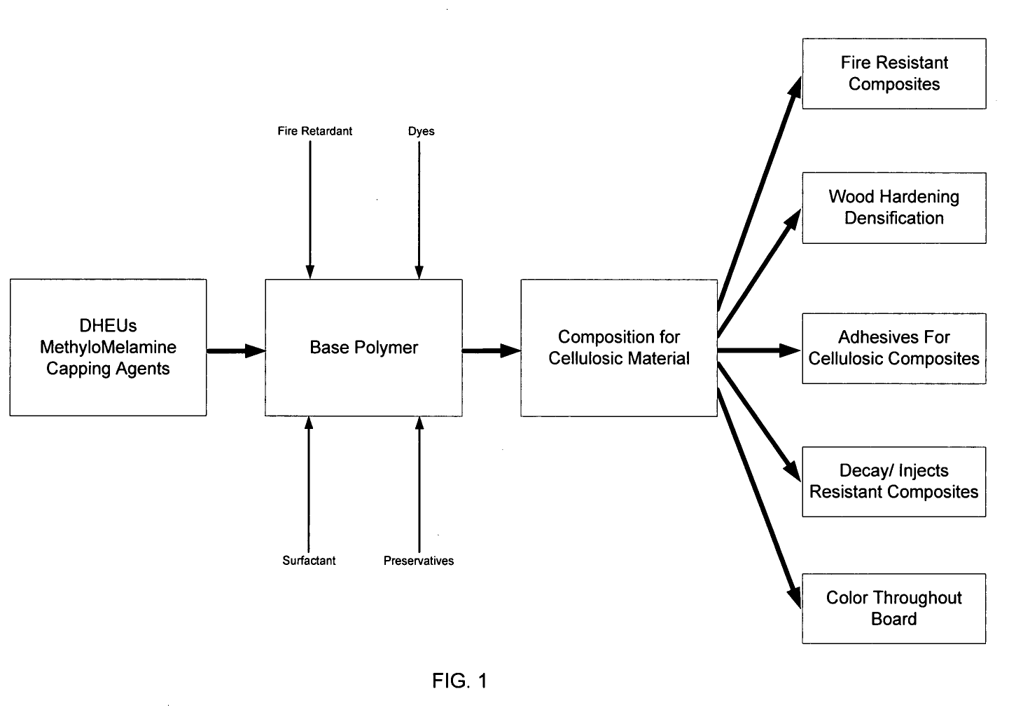

### DETAILED DESCRIPTION

The following description concerns a base polymer composition, optional auxiliary additives that can be added to the base polymer, and a process for forming cellulosic products using various embodiments of the composition. Working examples, along with test data for exemplary embodiments of cellulosic composites, also are disclosed. A person of ordinary skill in the art will appreciate that the following disclosure is exemplary only, and that the scope of the invention is not limited to the particular features disclosed.

### I. Base Polymer Composition

A. Condensation Products from Reaction of Urea and Glyoxal

Certain embodiments of the present composition include both 5-membered ring systems, as well as 6-membered ring systems (5 and 6-membered ring systems are shown below). These can include condensation products that result by reacting urea with dialdehydes, such as Glyoxal and malonaldehyde. These systems are primarily exemplified herein by reference to hydroxyethylene ureas (DHEU) and dihydroxypropanol ureas (DHPU) (with chemical formulae shown below), or a derivative, an oligomer or oligomers, and/or a polymer or polymers thereof. With reference to the general formula, R independently is H, aliphatic, more typically lower (10 carbon atoms or fewer) aliphatic, and even more particularly lower alkyl, CH(OH)CHO, or combinations thereof, and Y is oxygen or sulfur, typically oxygen. 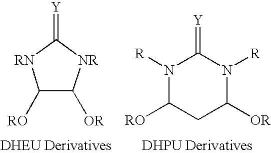
While the R groups for the general formulae can vary, and can be virtually any chain length, there are certain practical considerations that limit these R groups. For example, a person of ordinary skill in the art will appreciate that varying these side groups may also affect solubility, pH, penetration rates, reaction rates, etc., and combinations of such factors. Thus, there may be an inverse relationship between the length of the R groups and such factors, e.g. as chain length increases solubility and penetration reaction rates typically decrease.

DHEU may be purchased for use as disclosed herein, but preferably is made on site by reacting from about 1:1 to about 1:3 molar equivalents of urea (NH₂CONH₂) with the dialdehyde glyoxal (OHCCHO). A person of ordinary skill in the art will recognize that other starting materials might be used to provide plural useful compositions. For example, a substituted urea and glycoluril (shown below, where R typically is H, lower aliphatic, particularly lower alkyl, CH(OH)CHO, or combinations thereof) or dialdehyde might be used. 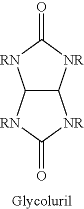
Examples of substituted ureas and dialdehydes include those made by replacing one or more hydrogen atoms with lower aliphatic groups, including alkyl groups, such as methyl (—CH₃).
B. Methylol Melamine

Melamine (2,4,6-triamino-1,3,5 triazine, CAS number 106-78-1, shown below) is a white crystalline powder with a melting point of approximately 354° C. and a density of 1.573 grams/cc. 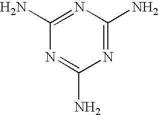
Methylol melamine, shown below, is used in certain disclosed embodiments of the present polymeric composition, where X is 0, 1 or 2. 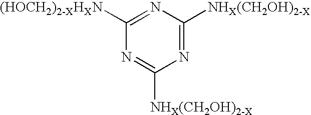
While it may be possible to purchase the methylol melamine, it also can be produced onsite by reacting formaldehyde with melamine.

Derivatives, or compounds similar to, melamine also may be used to practice certain embodiments of the present invention. For example, ammeline, shown below, also can be used to practice disclosed embodiments. 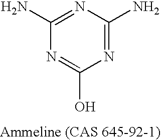
Thus, with respect to compounds of this particular reactant, 6-membered ring systems have a general formula as indicated below. 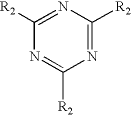
With reference to this general formula, R₂ is an amine, an hydroxyl group, a sulfhydryl group, or combinations thereof, with R₂ more typically being amine and hydroxyl, and even more typically at least two of the R₂ groups typically are amine functional groups, or amine derivatives, such as methylol derivatives.
C. Capping Agents

Disclosed base compositions can polymerize prior to application to or impregnation of cellulosic materials for making composite products. Polymerization, at least substantial polymerization, may be detrimental. For example, if the polymerization occurs too readily, it may not be possible to effectively impregnate a cellulosic structure, such as a board product, throughout the entire cross section or desired portion of the cross section. The inability to fully penetrate throughout the cross section, or desired portion of the composite product cross section, may result from increased molecular weight and size of the polymerized product, which can preclude or substantially reduce the rate at which the composition penetrates into and throughout the porous cellulosic structure.

There are ways to control the polymerization. For example, the composition pH can be adjusted to provide a pH that is determined best for inhibiting polymerization. A suitable pH range for controlling polymerization to allow subsequent formation of cellulosic products is from about 2 to about 11, typically from about 4 to about 10, and more typically from about 6 to about 9.

Alternatively, a capping agent or agents can be used. Suitable capping agents typically reversibly react with reactive groups, such as hydroxyl groups, present on constituent materials, such as methylol melamine, to reversibly terminate or prevent polymerization of the product until desired. A person of ordinary skill in the art will recognize that a number of capping agents are useful. However, certain disclosed working embodiments used an alcohol or a polyol, such as a glycol, particularly alkylene glycols, including ethylene glycol, as a capping agent. Glycols react with terminal hydroxyl groups on methylol melamine to form ethyl ethers. However, virtually any alcohol potentially can be used as the capping agent, and hence other considerations, can be used to select suitable capping agents for particular applications. Such other considerations include capping efficiency, with small chain alcohols providing better capping efficiency; solubility, with longer chains having decreased aqueous solubility and potentially forming solids at temperatures typically used to practice disclosed embodiments; recovery; price; and combinations of such considerations. Moreover, under certain conditions, naturally occurring hydrophilic polymers, such as maltodextrin, also can be used as the capping agent.

D. Auxiliary Additives

Useful compositions can include optional auxiliary agents. For example, surfactants, pigments, dyes, UV stabilizers, etc., and combinations thereof, optionally can be added to the base composition. Surfactants can be added for a number of reasons, including facilitating wetting of cellulosic fibers, to facilitate dissolution and/or suspension of other materials added to the base composition, such as dyes, pigments, UV stabilizes, etc. For example, dyes are known to precipitate from compositions during the production process. If dyes precipitate, cellulosic products impregnated with the composition have discontinuous dye concentrations, which substantially varies and/or changes aesthetic product value.

1. Surfactant

A person of ordinary skill in the art will recognize that any surfactant compatible with the base composition and useful for making cellulosic composite products now known or hereafter developed can be used with the present invention. Solely by way of example and without limitation, non-ionic surfactants have been used to produce working embodiments. Surfactant properties generally considered to select a surfactant, or mixture of surfactants, useful for practicing disclosed embodiments include miscibility with other reactants and foaming properties. Both ionic and non-ionic surfactants can be used. It has been found that Si- and F-containing surfactants are particularly useful. Examples of useful-ionic surfactant include, without limitation, the nonionic surfactant sold by DuPont Chemical Company as Telomer, and Surfynol, which is sold by Air Products and Chemicals, Inc.

2. Trialkanolamines

Trialkanolamines, such as triethanolamine, provide another example of an optional auxiliary compound or compounds that can be added to form presently disclosed cellulosic treatment compositions. Trialkanolamines can be used for a variety of purposes, including in amounts effective as capping agents, in amounts effective to provide a desired pH, such as a pH in the range of from about 8 to about 9. A person of ordinary skill in the art will recognize that other pH modifiers can be used, either alone, or in any combination, such as ammonium or quaternary amines. The trialkanol amines also can be used to stabilize cross-linkers, and inhibit certain materials from precipitating from the compositions, as discussed above with reference to dyes.

3. Preservative

Preservatives can be added to the base polymer. Any preservative, or combinations of preservative, now known or hereafter developed and compatible with cellulosic composite products can be used to form the present cellulosic treatment compositions. Solely by way of example, and without limitation, useful preservatives include borates, benzoates, carbonates, carboxylates, amine oxides, amine ethoxylates (See Barth et al. U.S. Pat. No. 6,506,795, which is incorporated herein by reference), metal azoles, etc. Particular compounds include sodium benzoate, chromated copper arsenate, didecyl dimethyl ammonium carbonate, didecyl dimethyl ammonium bicarbonate, copper quaternary amine compounds, copper boron azole, copper azole, acid copper chromate, copper citrate, sodium borate, zinc borate, and combinations thereof. The materials are used in amounts effective to act as a preservative, such as in amounts ranging from about 0.01% to about 5%, and more typically from about 0.1% to about 1% w/w relative to weight of the base polymer.

4. Fire Retardant

Chemco, Inc., the assignee of the present invention, is known for making fire retardant cellulosic composites. Fire retardant materials can be used to form cellulosic treatment compositions disclosed herein. For example, the '394, which is incorporated herein by reference, discloses certain fire retardant materials and fire retardant effective amounts that can be used for the present invention. Examples, without limitation, of useful fire retardant materials include phosphates, nitrogen phosphates, such as melamine phosphates, borates, silicates, and combinations thereof. Fire retardants are used in amounts effective as a fire retardant. Effective amounts typically range from greater than 0% to less than 100%, more typically from about 1 to about 40% w/w relative to the weight of the base polymer, and more typically from about 5% to about 15% w/w.

5. Aesthetic Materials

Modern cellulosic composites typically include materials that are solely added for aesthetic purposes, such as dyes, pigments, and UV stabilizers. Thus, any such aesthetic material, and combinations thereof, that are now known or hereafter developed and are useful for making cellulosic composites compatible with the disclosed compositions can be used to form cellulosic composites.

6. Hardness Enhancers

Additives that increase the hardness of the cellulosic composite can be used. The beneficial addition of hardness enhancers depends on a number of factors, as will be understood by a person of ordinary skill in the art, including the end application intended for a particular embodiment of a cellulosic composite. For example, flooring and decking likely would benefit from increased relative hardness compared to other possible products. Hardness enhancers may be added to cellulosic materials in amounts effective to increase the hardness to a level suitable to the end use, such as hardness values ranging from about 1,000 LBF (pound-force) to about 3,500 LBF, with amounts of hardness enhancers required to achieve these hardness values ranging from about 0.3% to about 50%, and more typically from about 1% to about 20% w/w relative to the base polymer composition. Examples, without limitation, of hardness enhancers include nanoclays, silicates, inorganic salts, such as Borax and low-solubility borate salts, and combinations thereof. “Nanoclay” refers to materials typically having dimensions of from about 0.0001 μm to about 10 μm, more typically from about 0.0001 μm to about 5 μm.

7. Water Repellants

Certain disclosed embodiments of the present invention also can include at least one water repellant. Suitable water repellants include paraffin wax emulsions, such as those provided by Michelman, one example being MICHEM LUBE.

8. Functional Polymer or Crosslinking Agent

Functional polymer or crosslinking agents also can be added to the base composition in amounts effective to co-polymerize, crosslink and/or form a polymer interpenetrating network, of at least a portion of polymeric materials used to form desired products. Suitable crosslinking agents typically include plural functional groups, such as hydroxyl (—OH) groups, that are reactive with the particular polymeric material.

One example of a useful cross-linker/copolymer is maltodextrin. Maltodextrin can be added either as an aqueous solution or as a dry powder. Moreover, maltodextrin having various DE values can be used, as long as polysaccharide depolymerization has not progressed to an extent deleterious to the cellulosic composite product. Addition of dry powdered maltodextrin advantageously avoids formulating solutions comprising the maltodextrin, and thereby obviates a processing step. Cellulosic products having increased maltodextrin concentrations also can be made using powdered maltodextrin relative to products made using solutions of maltodextrins.

Maltodextrin DE can vary for use in cellulosic composites. Solely by way of example and without limitation, it currently is believed that the maltodextrin DE useful for making cellulosic products of the present invention can vary from about 4 to about 25, more typically from about 4 to 12, and even more typically from about 4 to 10. Maltodextrin is sold commercially in various DE ranges, such as compositions from 4 to 6, 6 to 10, and 8 to 12 batches. Each of these can be used alone or in combination. When used in combination for working embodiments, the average DE has been about 10.

Maltodextrin is relatively inexpensive, naturally derived, and safe to use compared to other materials used to form desired cellulosic composite products, and increasing the concentration of maltodextrin used therefore advantageously reduces the production cost. Maltodextrin amounts used to make embodiments of the disclosed composition ranges from zero, as it is an optional material, to as high as possible without compromising product performance, which typically ranges from about 0 to about 95%, more typically from about 50% to about 90% w/w relative to the weight of the base polymer.

### II. Process for Forming Compositions

The following paragraphs describe embodiments of a process for forming base compositions, and compositions comprising optional auxiliary additives. A person of ordinary skill in the art will recognize that additional and/or alternative procedures may be used to form cellulosic compositions.

One possible process first forms an aqueous formaldehyde composition pH-adjusted to a desired pH, such as a pH of greater than about 7.0, to provide polymerization control. The pH can be adjusted by adding an amount of a pH adjuster, including either an acid or base, effective to obtain a suitable pH. Examples of materials useful as pH adjusters include, without limitation, typical Bronsted-Lowery acids and bases, such as aqueous metal hydroxides, including sodium hydroxide, hydrogen halides, such as hydrogen chloride, and combinations of acids and bases.

The aqueous formaldehyde composition is then combined with melamine. The composition may react to form methylol melamine, and complete reaction generally is undesirable at this point in the process. The aqueous formaldehyde composition is combined with melamine and generally the composition is processed at an increased temperature relative to ambient. This temperature can vary, and certain end points are set by functional considerations, including the boiling point of aqueous solutions and using process temperatures that prevent, or at least substantially prevent, cellulose degradation. This effective processing temperature typically is greater than ambient to less than about 100° C., and more typically from about 65° C. to less than about 100° C. Moreover, a person of ordinary skill in the art will appreciate that temperature selection also effects reaction rate, with higher temperatures facilitating faster reactions. With reference to the melamine-formaldehyde reaction, at room temperature the reaction can take days to months; at 30° C. to about 40° C., the reaction takes days to complete; at from about 55° C. to about 70° C. the reaction is complete in a few hours; and at temperatures greater than about 70° C. to about 90° C., the reaction may take only minutes or seconds. The composition comprising aqueous formaldehyde and melamine is maintained at the selected processing temperature and mixed effectively, such as by stirring, for a suitable period of time, typically from about 5 minutes to about 60 minutes for working embodiments.

A capping agent can now be added. As with pH adjustment, capping agents also help preclude complete polymerization of the aqueous formaldehyde/melamine composition. As described above, one useful capping agent is ethylene glycol. The relative amount of the capping agent can be varied, but has been used in approximately 1-to-1 functional groups relative to the amount of formaldehyde added.

The composition formed above is then combined with DHEUs, again to form a composition generally processed at an elevated temperature of approximately 90° C. The composition is mixed effectively using any suitable means for a suitable period of time. A working embodiment of the process included mixing periods of from about 5 minutes to about 10 minutes. The composition then typically is allowed to cool to a temperature lower than the initial processing temperature between ambient to less than 90° C.

Auxiliary materials are now optionally added. For example, a surfactant, or combination of surfactants, is added in the minimal amount effective for the desired purpose, such as to facilitate fiber wetting and/or to minimize the degree to which the composition foams. Too much surfactant can have deleterious effects other than increased production costs, such as wetting of or water absorption by the composite product subsequent to its production. Working embodiments have been made using Telomer B surfactant in an approximate amount of from about 0.1 to about 0.5 ppm relative to the total volume of material impregnated with the product.

Once all desired auxiliary additives have been added, the composition is used to treat cellulosic materials to form a composite. Cellulosic materials can be any suitable material for making composite products, typically building products. Typically, the cellulosic material is wood obtained from various species and in various forms, such as chips, or smaller particles, fibers, etc., and combinations thereof.

Where maltodextrin is used, the concentrated composition first can be combined with maltodextrin and then added to cellulosic products, or alternatively the composition can be added to the cellulosic material and maltodextrin added subsequently. Product hardness can be quantified using a standard Janka hardness scale, accepted in the industry. The Janka hardness is determined using steel balls to penetrate the surface of a composite product. The Janka hardness is the force required to embed a steel ball, typically a 0.444 inch steel ball, halfway through the composite product. A person of ordinary skill in the art will recognize that the Janka hardness depends upon various factors, including the wood species used, but mostly the water content at the time hardness is measured. Cellulosic products of the present invention have Janka hardnesses ranging from about 900 pounds to about 3,500 pounds, and more typically from about 1,000 pounds to about 1,900 pounds. For example, for working embodiments made by adding maltodextrin concentrate to hybrid Poplar/Ponderosa Pine, the Janka hardness has been about 750-1,500 lbs. When the composition is added to harder cellulosic species, such as Radiata or Southern Yellow Pine, the Janka hardness will be greater, and can range from about 1,200 to about 3,500 lbs.

The amount of DHEUs added to the methlylol formaldehydes composition can vary significantly. For example, DHEUs can be added solely to the cellulosic material. In such situations, DHEUs can cross link with hydroxyl groups present on the cellulosic material itself. Alternatively, maltodextrin can be added to the DHEUs so that DHEUs react with the maltodextrin and/or cellulosic hydroxyl groups. As a further alternative, and as described above, DHEU can be added in various composition amounts relative to the methylol melamine composition. The amount of methylol melamine to DHEU can vary from about 0% to 100% w/w, typically 0% to 95% w/w, and even more typically 0% to about 60% w/w.

### III. Application/Impregnation of Cellulosic Materials

Compositions made as described above are then used to treat cellulosic materials. An aqueous treatment composition can be formulated as a relatively dilute aqueous solution with increasing concentrations up to a substantially viscous solution. The concentration of the treatment solution can range from about 5% to about 70%, more typically from about 10% to about 35%, and even more typically from about 20% to 35%. Cellulosic materials can be treated with cellulosic treatment compositions by any suitable technique, including spraying, painting, soaking, pressure treating, etc., and combinations thereof. For working embodiments, cellulosic treatment compositions have been applied to cellulosic materials in an autoclave. The autoclave is filled with an amount of the cellulosic treatment composition sufficient to substantially immerse any cellulosic products placed into the autoclave. The pressure of the autoclave is reduced from ambient to a pressure of from about −22 inches (−558 mm Hg) to −28 inches of mercury (−712 mm Hg), as determined at sea level.

The pressure within the autoclave subsequently can be increased to a level and for a period of time sufficient to apply and/or impregnate the cellulosic products placed in the autoclave to the desired amount. Working embodiments have used impregnation pressures of from about 50 psi to about 200 psi. However, higher pressures also likely can be used up to pressures at which cellulosic degradation occurs. The degree to which the composition penetrates the cellulosic material can be determined by adjusting several factors, as will be understood by a person of ordinary skill in the art, including the applied pressure and the time associated with the impregnation process. For example, at an applied pressure of 150 psi the application time typically ranges for a time period of from about 30 minutes to several hours. For certain products comprising dyes, it is desirable, but not necessary, to have the composition substantially completely penetrate the cross-section of the cellulosic material. In this manner, any subsequent processing of the board product, such as sanding, will not produce areas where dye is present and where dye is not present. For other applications, while the degree of penetration into the cellulosic product can vary, with boards having a 1-inch thickness penetration typically totals about ¾ of an inch, i.e. about ⅜ of an inch in from each planar surface of the cellulosic material. A person of ordinary skill in the art will appreciate that board product characteristics, including aesthetic characteristics, such as color, may vary with different temperature and/or pressure regimens.

Once impregnated for a targeted period of time, the cellulosic materials are removed from the autoclave and dried. For example, the products can be kiln dried to obtain a suitable moisture content, such as below about 10%.

### EXAMPLES

The following examples are provided to exemplify particular features of working embodiments. A person or ordinary skill in the art will appreciate that the invention is not limited to these exemplary features.

### Example 1

This example describes a composition, referred to as Resin 1, for application to cellulosic materials. A first mixture was formed comprising 145 kg of 40% aqueous glyoxal and 60 kg of urea. This first mixture was heated to a temperature within the range of from about 60° C. to about 90° C. A second mixture was formed comprising 126 kg melamine, 90 kg of 37% aqueous formaldehyde solution and 124 kg of ethylene glycol. The first and second mixtures were combined and heated to 80-100° C. for 20-45 minutes. The viscosity of the resin was 100-600 cps, and had a solid contents of 45-50%

### Example 2

This example describes a composition, referred to as Resin 2, for application to cellulosic materials. A first mixture was formed comprising 435 kg of 40% aqueous glyoxal, 1,400 kg Maltodextrin with DE of 8-12, 180 kg Urea and 1,500 kg water. The mixture was heated for approximately 30 minutes to 60 minutes, and 7 kg sodium benzoate was added. The viscosity of the resin was 3,000-6,000 cps, with a solids content of 50-65%, and a density of about 1.27-1.32 grams/cubic centimeter.

### Example 3

This example describes a composition, referred to as Resin 3, for application to cellulosic materials. A first mixture was formed comprising 264 kg of maltodextrin with a DE of 8-12, 615 kg of water, 122 kg of resin 1, 0.5 kg of Telemor, and 2 kg of sodium benzoate. The density of the solution was 1.13 g/cc, and the solids content was 30-33%.

### Example 4

This example describes applying Resin 1 to cellulosic material. Resin 1 was diluted to a 30% aqueous solution. Solid pieces of Ponderosa Pine were placed in an autoclave. A vacuum of −26 inch of mercury (−660.4 mm Hg) was applied to the interior of the autoclave for 30 minutes. After 30 minutes, Resin 1 solution was injected into the autoclave interior so as to fully contact the exterior surfaces of each piece of wood therein. The pressure in the autoclave was then increased to 130-150 psi by pumping the solution through a high-pressure pump. The treated wood was then dried, cured and stabilized with a predetermined curing program cycle, such as being dried at 95-100° C. for 36-48 hours. Resin 1 enhanced wood had a density of 0.60 g/cc and a Janka Hardness of about 1,440 pounds, compared to an untreated Ponderosa Pine density of 0.35 g/cc and a Janka Hardness of about 400 pounds.

### Example 5

This example describes applying Resin 2 to cellulosic material. Resin 2 was diluted to form a 33% aqueous solution. Pieces of solid Radiata Pine wood were placed in an autoclave. A vacuum of −26 inch of mercury (−660.4 mm Hg) was applied to the interior of the autoclave for 30 minutes. After 30 minutes, Resin 2 solution was injected into the autoclave interior so as to fully contact the exterior surfaces of each piece of wood therein. The pressure in the autoclave was then increased to 130-150 psi by pumping the solution through a high-pressure pump. The treated wood was then dried, cured and stabilized with a predetermined curing program cycle, such as oven dried at 95-100° C. for 48-60 hours. Resin 2 enhanced Radiata Pine had a density of 0.60-0.75 g/cc and a Janka Hardness of from about 900 to about 1,600 pounds, compared to untreated Radiata Pine density of 0.45-0.50 g/cc and a Janka Hardness of from about 550 to about 850 pounds.

### Example 6

This example describes applying Resin 3 to cellulosic material. 1 kg of metalized anionic dyes and 0.5 kg triethanolamine were added to 100 kg resin 3. Solid Radiata Pine wood was placed in an autoclave. A vacuum of −26 inch of mercury (−660.4 mm Hg) was applied to the interior of the autoclave for 30 minutes. After 30 minutes, Resin 3 mixture was injected into the autoclave interior so as to fully contact the exterior surfaces of each piece of wood therein. The pressure in the autoclave was then increased to 130-150 psi by pumping the solution through a high-pressure pump. The treated wood was oven dried using a predetermined curing program cycle, such as about 65° C.-100° C. for 48-60 hours. The following table lists typical properties of Radiata Pine treated in this application.

TABLE 1

| | Hardness | | | | | Surface |
|---|---|---|---|---|---|---|
| | (compared to | | | Formaldehyde | | Burning |
| | untreated Radiata | | | (JIS/JAS | Dimensional | Character |
| | Pine) | Density | Strength | Standards) | Stability | (ASTM-E84) |
| Treated | 145%-250% | 560 kg/m³-800 kg/m³ | MOR | <0.4 ppm | Tangential | Class B |
| Radiata | | | 14,300 lb/in² | | 1.1% | SFI-40 |
| Pine | | | MOE | | Radial | SDI-45 |
| | | | 1,400,000 lb/in² | | 0.7% | |
| Red Oak | 140-200% | 590 kg/m³-675 kg/m³ | MOR | <0.4 ppm | Tangential | Class C |
| | | | 13,900 lb/in² | | 1.8-2.9% | SFI-100 |
| | | | MOE | | Radial | SDI-100 |
| | | | 1,640,000 lb/in² | | 0.9-1.5% | |
| Untreated | 550 lb-850 lb | 350 kg/m³-600 kg/m³ | MOR | <0.4 ppm | Tangential | N/A |
| Radiata | | | 11,700 lb/in² | | N/A | |
| Pine | | | MOE | | Radial | |
| | | | 1,480,000 lb/in² | | N/A | |

### Example 7

This example describes applying Resin 3 to cellulosic material. 1 kg of metalized anionic dyes and 3 kg disodium octaborate tetrahydrate (DOT) were added to 100 kg of Resin 3. Solid pieces of Radiata Pine were placed in an autoclave. A vacuum of −26 inch of mercury (−660.4 mm Hg) was applied to the interior of the autoclave for 30 minutes. After 30 minutes, Resin 3 was injected into the autoclave interior so as to fully contact the exterior surfaces of each piece of wood therein. The pressure in the autoclave was then increased to 130-150 psi by pumping the solution through a high-pressure pump. The treated wood was oven dried at 95-100° C. for 48-60 hours. The Janka Hardness of the board was found to be 10-20% higher than the board treated with Resin 3 solution without DOT.

### Example 8

This example describes applying Resin 3 to cellulosic material. Pieces of 1/16 Yellow Cedar veneer were placed in an autoclave. A vacuum of −26 inch of mercury (−660.4 mm Hg) was applied to the interior of the autoclave for 30 minutes. After 30 minutes, Resin 3 was injected into the autoclave interior so as to fully contact the exterior surfaces of each piece of wood therein. The pressure in the autoclave was then increased to 130-150 psi by pumping the solution through a high-pressure pump. The treated veneer was then oven dried at 95-100° C. for 24-36 hours. The veneer were later stacked and made into 20-ply LVL (laminated veneer lumber). The LVL had a density of 0.72, water absorption 9.2%, volumetric expansion 0.5% versus yellow cedar lumber of density 0.46 g/cc, water absorption 50% and volumetric expansion 3.8%.

The present invention has been described with reference to certain exemplary embodiments. A person of ordinary skill in the art will appreciate that the scope of the invention is not limited to those features exemplified by the disclosed embodiments.

We claim:

1. A composition useful for forming cellulosic products comprising an effective amount of a 5-membered ring compound, a 6-membered ring compound, or combinations thereof, that result by reacting urea with a dialdehyde.

2. The composition according to claim 1 comprising dihydroxyethylene ureas, glycolurils, dihydroxypropanol ureas, or combinations thereof.

3. The composition according to claim 1 further comprising methylol melamine.

4. The composition according to claim 1 further comprising a crosslinking agent.

5. The composition according to claim 1 where the compounds have a formula 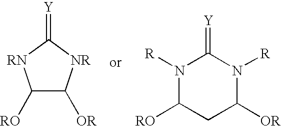
where R independently is H, aliphatic, CH(OH)CHO, or combinations thereof, and Y is oxygen or sulfur.

6. The composition according to claim 5 where Y is oxygen.

7. The composition according to claim 5 where R independently is hydrogen or lower aliphatic.

8. The composition according to claim 5 where Y is oxygen and R independently is hydrogen or lower alkyl.

9. The composition according to claim 1 further comprising maltodextrin.

10. The composition according to claim 9 where the maltodextrin has a DE of from 4 to about 25.

11. The composition according to claim 1 comprising an aqueous solvent, an organic solvent, or combinations thereof.

12. The composition according to claim 1 further comprising a surfactant, a trialkanolamine amine, a preservative, a fire retardant, an aesthetic material, a hardness enhancer, or combinations thereof.

13. The composition according to claim 12 where the trialkanolamine is a lower alkyl trialkanolamine.

14. The composition according to claim 13 where the trialkanolamine is triethanolamine.

15. The composition according to claim 12 where the preservative is a borate, a benzoate, a carbonate, a carboxylate, an amine oxide, an amine ethoxylate, metal azole, or combinations thereof.

16. The composition according to claim 12 where the preservative is sodium benzoate, chromated copper arsenate, didecyl dimethyl ammonium carbonate, didecyl dimethyl ammonium bicarbonate, copper quaternary amine compounds, copper boron azole, copper azole, acid copper chromate, copper citrate, sodium borate, zinc borate, or combinations thereof.

17. The composition according to claim 12 where the hardness enhancer is a nanoclay, a silicate, an inorganic salt, a borate or combinations thereof.

18. The composition according to claim 12 where the aesthetic material is a dye, a pigment, or combinations thereof.

19. The composition according to claim 1, comprising effective amounts of dihydroxyethylene ureas, glycolurils, dihydroxpropanol ureas, methylol melamine, maltodextrin having a DE of from 4 to about 25, and an auxiliary additive selected from surfactants, trialkanolamine amines, preservatives, fire retardants, aesthetic materials, hardness enhancers, or combinations thereof.

20. The composition according to claim 1, comprising effective amounts of dihydroxyethylene ureas, glycolurils, dihydroxypropanol ureas, methylol melamine, maltodextrin having a DE of from 4 to about 12, a surfactant, a trialkanolamine amine, a preservative selected from borates, benzoates, carbonates, carboxylates, amine oxides, amine ethoxylates, metal azole, or combinations thereof, a hardness enhancer selected from nanoclays, silicates, inorganic salts, borates, or combinations thereof, a fire retardant, and an aesthetic material.

21. A cellulosic product, comprising cellulosic material and an effective amount of a composition initially comprising a 5-membered ring compound, a 6-membered ring compound, or combinations thereof, that result by reacting urea with a dialdehyde or dialdehydes.

22. The product according to claim 21 comprising dihydroxyethylene ureas, glycolurils, dihydroxypropanol ureas, or combinations thereof.

23. The product according to claim 21 further comprising methylol melamine.

24. The product according to claim 21 where the composition further comprises a crosslinking agent.

25. The product according to claim 21 where the compounds have a formula 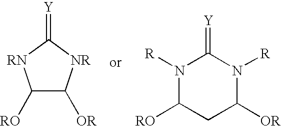
where R independently is H, aliphatic, CH(OH)CHO, or combinations thereof, and Y is oxygen or sulfur.

26. The product according to claim 25 where Y is oxygen.

27. The product according to claim 25 where R is lower aliphatic.

28. The product according to claim 25 where R is lower alkyl and Y is oxygen.

29. The product according to claim 21 whether the composition further comprises maltodextrin having a DE of from about 4 to about 25.

30. The product according to claim 21 where the product, composition, or both, further comprise a surfactant, a trialkanolamine amine, a preservative, a fire retardant, an aesthetic material, a hardness enhancer, or combinations thereof.

31. The product according to claim 30 where the trialkanolamine is a lower alkyl trialkanolamine.

32. The product according to claim 30 where the preservative is a borate, a benzoate, a carbonate, a carboxylate, an amine oxide, an amine ethoxylate, metal azole, or combinations thereof.

33. The product according to claim 30 where the hardness enhancer is a nanoclay, a silicate, an inorganic salt, a borate or combinations thereof.

34. The product according to claim 30 where the aesthetic material is a dye, a pigment, or combinations thereof.

35. The product according to claim 21 where the composition comprises effective amounts of dihydroxyethylene ureas, glycolurils, dihydroxpropanol ureas, methylol melamine, and maltodextrin having a DE of from about 4 to about 25.

36. The product according to claim 35 further comprising an auxiliary additive.

37. The product according to claim 21 where the product, composition, or both, comprises effective amounts of dihydroxyethylene ureas, glycolurils, dihydroxypropanol ureas, methylol melamine, maltodextrin having a DE of from about 4 to about 12, a surfactant, a trialkanolamine, a preservative selected from borates, benzoates, carbonates, carboxylates, amine oxides, amine ethoxylates, metal azole, or combinations thereof, a hardness enhancer selected from nanoclays, silicates, inorganic salts, borates, or combinations thereof, a fire retardant, and an aesthetic material.

38. The product according to claim 21, comprising wood having applied thereto, or substantially impregnated with, a composition comprising effective amounts of dihydroxyethylene ureas, glycolurils, dihydroxypropanol ureas, methylol melamine, and maltodextrin having a DE of from about 4 to about 25.

39. The product according to claim 38 further comprising an auxiliary additive.

40. The product according to claim 21, comprising wood material having applied thereto, or substantially impregnated with, a composition comprising an effective amount of a 5-membered ring compound, a 6-membered ring compound, or combinations thereof that result by reacting urea with a dialdehyde, the compound or compounds having a formula 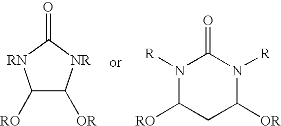
where R independently is H, aliphatic, CH(OH)CHO, or combinations thereof, methylol melamine, maltodextrin, and an auxiliary additive selected from the group consisting of a surfactant, a trialkanolamine amine, a preservative, a fire retardant, an aesthetic materials a hardness enhancer, or combinations thereof.

41. A wood product having a dye material penetrating substantially completely through a cross section of the product.

42. The wood product according to claim 41 further comprising a composition initially comprising dihydroxyethylene ureas, dihydroxypropanol ureas, glycolurils, or combinations thereof.

43. A method for making a cellulosic product, comprising:
providing a composition comprising an effective amount of a 5-membered ring compound, a 6-membered ring compound, or combinations thereof, that result by reacting urea with a dialdehyde or combinations of dialdehydes; and
applying the composition to cellulosic material.

44. The method according to claim 43 where the composition initially comprises dihydroxyethylene ureas, glycolurils, dihydroxypropanol ureas, or combinations thereof.

45. The method according to claim 44 where the composition comprises methylol melamine.

46. The method according to claim 44 where the composition further comprises a crosslinking agent.

47. The method according to claim 43 where the compound or compounds have a formula 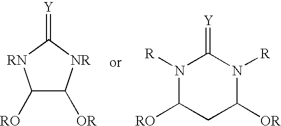
where R independently is H, aliphatic, CH(OH)CHO, or combinations thereof, and Y is oxygen or sulfur.

48. The method according to claim 47 where Y is oxygen.

49. The method according to claim 47 where R is lower aliphatic.

50. The method according to claim 47 where R is lower alkyl and Y is oxygen.

51. The method according to claim 47 where the composition further initially comprises maltodextrin having a DE of from about 4 to about 25.

52. The method according to claim 43 where the composition further comprises a surfactant, a trialkanolamine amine, a preservative, a fire retardant, an aesthetic material, a hardness enhancer, or combinations thereof.

53. The method according to claim 52 where the trialkanolamine is a lower alkyl trialkanolamine.

54. The method according to claim 52 where the preservative is a borate, a benzoate, a carbonate, a carboxylate, an amine oxide, an amine ethoxylate, metal azole, or combinations thereof.

55. The method according to claim 52 where the preservative is sodium benzoate, chromated copper arsenate, didecyl dimethyl ammonium carbonate, didecyl dimethyl ammonium bicarbonate, copper quaternary amine compounds, copper boron azole, copper azole, acid copper chromate, copper citrate, sodium borate, zinc borate, or combinations thereof.

56. The method according to claim 52 where the hardness enhancer is a nanoclay, a silicate, an inorganic salt, a borate or combinations thereof.

57. The method according to claim 52 where the aesthetic material is a dye, a pigment, or combinations thereof.

58. The method according to claim 43, where the composition initially comprises effective amounts of dihydroxyethylene ureas, glycolurils, dihydroxpropanol ureas, methylol melamine, and maltodextrin having a DE of from about 4 to about 12.

59. The method according to claim 58 where the composition further initially comprises an auxiliary additive selected from surfactants, trialkanolamine amines, preservatives, fire retardants aesthetic materials, hardness enhancers, or combinations thereof.

60. The method according to claim 43, where the composition comprises effective amounts of dihydroxyethylene ureas, glycolurils, dihydroxypropanol ureas, methylol melamine, maltodextrin having a DE of from 4 to about 25, a surfactant, a trialkanolamine amine, a preservative selected from borates, benzoates, carbonates, carboxylates, amine oxides, amine ethoxylates, metal azole, or combinations thereof, a hardness enhancer selected from nanoclays, silicates, inorganic salts, borates, or combinations thereof, a fire retardant, and an aesthetic material.

61. The method according to claim 43 where the composition comprises effective amounts of a dihydroxyethylene urea, a dihydroxypropanol urea, methylol melamine, maltodextrin having a DE of from 4 to about 12, and an auxiliary additive selected from the group consisting of a surfactant, a trialkanolamine amine, a preservative, a fire retardant, an aesthetic material, a hardness enhancer, and combinations thereof, and applying comprises substantially immersing board products in the composition.

62. The method according to claim 61 where the board product has a one-inch thickness and substantially impregnating comprises impregnating through about ¾ inch cross section.

63. The method according to claim 62 where applying comprises substantially immersing the board products in the composition in an autoclave, and increasing the pressure in the autoclave to greater than ambient.

64. A method for making a board product, comprising:
providing a board product; and
applying a dye material to the board product to provide dye material substantially completely through a cross section of the product.

65. The method according to claim 64 further comprising applying the dye material using a composition that comprises effective amounts of a dihydroxyethylene urea, glycolurils, a dihydroxypropanol urea, methylol melamine, and a maltodextrin having a DE of from 4 to about 25, and an auxiliary additive selected from the group consisting of a surfactant, a trialkanolamine amine, a preservative, a fire retardant, an aesthetic materials a hardness enhancer, and combinations thereof.
